(19) United States
(12) Patent Application Publication
(10) Pub. No.: US 2021/0368165 A1
(43) Pub. Date: Nov. 25, 2021

(54) IMAGE DECODING METHOD BASED ON CCLM PREDICTION, AND DEVICE THEREFOR

(71) Applicant: LG ELECTRONICS INC., Seoul (KR)

(72) Inventors: Jangwon CHOI, Seoul (KR); Seunghwan KIM, Seoul (KR); Jin HEO, Seoul (KR)

(21) Appl. No.: 17/390,654

(22) Filed: Jul. 30, 2021

Related U.S. Application Data
(63) Continuation of application No. PCT/KR2020/003093, filed on Mar. 5, 2020.
(60) Provisional application No. 62/814,830, filed on Mar. 6, 2019.

(51) Int. Cl. H04N 19/105; H04N 19/132; H04N 19/159; H04N 19/82; H04N 19/186; H04N 19/176

(52) U.S. Cl. CPC H04N 19/105; H04N 19/132; H04N 19/176; H04N 19/82; H04N 19/186; H04N 19/159

(57) ABSTRACT

A method by which a decoding device performs image decoding, according to the present document, comprises the steps of: deriving an intra prediction mode of the current chroma block in a cross-component linear model (CCLM) mode; deriving downsampled luma samples on the basis of the current luma block; deriving downsampled neighboring luma samples on the basis of neighboring luma samples of the current luma block; and deriving CCLM parameters on the basis of the downsampled neighboring luma samples and neighboring chroma samples of the current neighboring chroma block, wherein when a color format is 4:2:2, the downsampled luma samples are derived by filtering three adjacent current luma samples.

### BACKGROUND OF THE DISCLOSURE

### Field of the Disclosure

The present disclosure relates to an image decoding method based on intra prediction according to CCLM, and an apparatus thereof.

### Related Art

Recently, demands for high-resolution and high-quality images, such as High Definition (HD) images and Ultra High Definition (UHD) images, have been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY OF THE DISCLOSURE

### Technical Objects

A technical object of the present disclosure is to provide a method and an apparatus for enhancing image coding efficiency.

Another technical object of the present disclosure is to provide a method and an apparatus for enhancing efficiency of intra prediction.

Yet another technical object of the present disclosure is to provide a method and an apparatus for enhancing efficiency of intra prediction based on a cross component linear model (CCLM).

Yet another technical object of the present disclosure is to provide an efficient encoding and decoding method of CCLM prediction, and an apparatus for performing the encoding and decoding method.

Yet another technical object of the present disclosure is to provide a method and an apparatus for selecting peripheral samples for deriving linear model parameters for CCLM.

Yet another technical object of the present disclosure is to provide a CCLM prediction method in 4:2:2 and 4:4:4 color formats.

### Technical Solutions

According to an embodiment of the present disclosure, provided herein is an image decoding method being performed by a decoding apparatus. In case an intra prediction mode for a current chroma block is a cross-component linear model (CCLM) mode, and if the color format is 4:2:2, the image decoding method may include the steps of deriving downsampled luma samples based on a current luma block, deriving downsampled neighboring luma samples based on neighboring luma samples of the current luma block, and deriving CCLM parameters based on the downsampled neighboring luma samples and neighboring chroma samples of a current neighboring chroma block, wherein when deriving the downsampled luma samples, the downsampled luma samples are derived by filtering three adjacent current luma samples.

At this point, if coordinates of a downsampled luma sample is (x, y), coordinates of the three adjacent luma samples, the three adjacent luma samples being first luma sample, second luma sample, and third luma sample, may be (2x−1, y), (2x, y), and (2x+1, y), respectively, and a ratio of filter coefficients being applied to the first luma sample, the second luma sample, and the third luma sample may be 1:2:1.

Additionally, if the color format is 4:2:2, the downsampled top neighboring luma samples may be derived by filtering three adjacent top neighboring luma samples of the current luma block.

In this case, if coordinates of a downsampled top neighboring luma sample is (x, y), coordinates of the three adjacent top neighboring luma samples, the three adjacent top neighboring luma samples being first top neighboring luma sample, second top neighboring luma sample, and third top neighboring luma sample, may be (2x−1, y), (2x, y), and (2x+1, y), respectively, and a ratio of filter coefficients being applied to the coordinates of the first top neighboring luma sample, the second top neighboring luma sample, and the third top neighboring luma sample may be 1:2:1.

According to another embodiment of the present disclosure, provided herein is a decoding apparatus performing an image decoding method. In case an intra prediction mode for a current chroma block is a cross-component linear model (CCLM) mode, and if the color format is 4:2:2, and when prediction is performed accordingly, the decoding apparatus may include a predictor deriving downsampled luma samples based on a current luma block, deriving downsampled neighboring luma samples based on neighboring luma samples of the current luma block, and deriving CCLM parameters based on the downsampled neighboring luma samples and neighboring chroma samples of a current neighboring chroma block. And, at this point, when deriving the downsampled luma samples, the downsampled luma samples are derived by filtering three adjacent current luma samples.

According to yet another embodiment of the present disclosure, provided herein is an image encoding method being performed by an encoding apparatus. In case an intra prediction mode for a current chroma block is a cross-component linear model (CCLM) mode, and if the color format is 4:2:2, the image encoding method may include the steps of deriving downsampled luma samples based on a current luma block, deriving downsampled neighboring luma samples based on neighboring luma samples of the current luma block, and deriving CCLM parameters based on the downsampled neighboring luma samples and neighboring chroma samples of a current neighboring chroma block. And, at this point, when deriving the downsampled luma samples, the downsampled luma samples are derived by filtering three adjacent current luma samples.

According to yet another embodiment of the present disclosure, provided herein is an encoding apparatus. The encoding apparatus may include a predictor deriving a cross-component linear model (CCLM) mode as an intra prediction mode of a current chroma block, and deriving a color format for the current chroma block, deriving downsampled luma samples based on a current luma block, deriving downsampled neighboring luma samples based on neighboring luma samples of the current luma block, and deriving CCLM parameters based on the downsampled neighboring luma samples and neighboring chroma samples of a current neighboring chroma block. And, if the color format is 4:2:2, the downsampled luma samples are derived by filtering three adjacent current luma samples

According to yet another embodiment of the present disclosure, provided herein is a digital storage medium, wherein image data including coded image information and bitstream generated according to an image encoding method is stored, the method being performed by an encoding apparatus.

According to a further embodiment of the present disclosure, provided herein is a digital storage medium, wherein image data including coded image information and bitstream is stored, the image data causing the image decoding method to be performed by a decoding apparatus.

### Effects of the Disclosure

According to the present disclosure, the overall image/video compression efficiency can be enhanced.

According to the present disclosure, the intra prediction efficiency can be enhanced.

According to the present disclosure, the image coding efficiency can be enhanced through performing of intra prediction based on CCLM.

According to the present disclosure, the CCLM-based intra prediction efficiency can be enhanced.

According to the present disclosure, the intra prediction complexity can be reduced by limiting the number of neighboring samples being selected to derive a linear model parameter for CCLM to a specific number.

According to the present disclosure, a CCLM prediction method in 4:2:2 and 4:4:4 color formats may be provided.

According to the present disclosure, a standard spec text performing CCLM prediction in 4:2:2 and 4:4:4 color formats may be provided.

According to the present disclosure, a method for downsampling or filtering a luma block for CCLM prediction in an image having 4:2:2 and 4:4:4 color formats may be proposed, and, by using this method, image compression efficiency may be enhanced.

Effects that can be obtained through detailed examples in the description are not limited to the above-mentioned effects. For example, there may be various technical effects that can be understood or induced from the description by a person having ordinary skill in the related art. Accordingly, the detailed effects of the description are not limited to those explicitly described in the description, and may include various effects that can be understood or induced from the technical features of the description.

### BRIEF DESCRIPTION OF THE DRAWINGS

FIG. 1 schematically illustrates an example of a video/image coding system to which embodiments of the present disclosure are applicable.

FIG. 2 is a diagram schematically explaining the configuration of a video/image encoding apparatus to which embodiments of the present disclosure are applicable.

FIG. 3 is a diagram schematically explaining the configuration of a video/image decoding apparatus to which embodiments of the present disclosure are applicable.

FIG. 4 exemplarily illustrates intra directional modes of 65 prediction directions.

FIG. 5 is a diagram explaining a process of deriving an intra prediction mode for a current chroma block according to an embodiment.

FIG. 6 illustrates 2N reference samples for parameter calculation for CCLM prediction.

FIG. 7 illustrates vertical and horizontal positions of luma samples and chroma samples of 4:2:0 color format.

FIG. 8 illustrates vertical and horizontal positions of luma samples and chroma samples of 4:2:2 color format.

FIG. 9 illustrates vertical and horizontal positions of luma samples and chroma samples of 4:4:4 color format.

FIG. 10 is a diagram for describing CCLM prediction for a luma block and a chroma block in a 4:2:2 color format according to an embodiment of the present disclosure.

FIG. 11 schematically illustrates an image encoding method performed by an encoding apparatus according to the present document.

FIG. 12 schematically illustrates an encoding apparatus for performing an image encoding method according to the present document.

FIG. 13 schematically illustrates an image decoding method performed by a decoding apparatus according to the present document.

FIG. 14 schematically illustrates a decoding apparatus for performing an image decoding method according to the present document.

FIG. 15 illustrates a structural diagram of a contents streaming system to which the present disclosure is applied.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

In this document, the term “A or B” may mean “only A”, “only B”, or “both A and B”. In other words, in the document, the term “A or B” may be interpreted to indicate “A and/or B”. For example, in the document, the term “A, B or C” may mean “only A”, “only B”, “only C”, or “any combination of A, B and C”.

A slash “/” or a comma used in this document may mean “and/or”. For example, “A/B” may mean “A and/or B”. Accordingly, “A/B” may mean “only A”, “only B”, or “both A and B”. For example, “A, B, C” may mean “A, B or C”.

In the document, “at least one of A and B” may mean “only A”, “only B”, or “both A and B”. Further, in the document, the expression “at least one of A or B” or “at least one of A and/or B” may be interpreted the same as “at least one of A and B”.

Further, in the document, “at least one of A, B and C” may mean “only A”, “only B”, “only C”, or “any combination of A, B and C”. Further, “at least one of A, B or C” or “at least one of A, B and/or C” may mean “at least one of A, B and C”.

Further, the parentheses used in the document may mean “for example”. Specifically, in the case that “prediction (intra prediction)” is expressed, it may be indicated that “intra prediction” is proposed as an example of “prediction”. In other words, the term “prediction” is not limited to “intra prediction”, and it may be indicated that “intra prediction” is proposed as an example of “prediction”. Further, even in the case that “prediction (i.e., intra prediction)” is expressed, it may be indicated that “intra prediction” is proposed as an example of “prediction”.

In the document, technical features individually explained in one drawing may be individually implemented, or may be simultaneously implemented.

Hereinafter, embodiments of the present disclosure will be described in detail with reference to the accompanying drawings. In addition, like reference numerals are used to indicate like elements throughout the drawings, and the same descriptions on the like elements will be omitted.

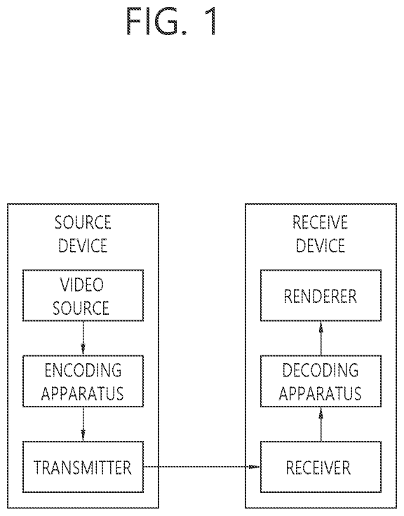

FIG. 1 briefly illustrates an example of a video/image coding device to which embodiments of the present disclosure are applicable.

Referring to FIG. 1, a video/image coding system may include a first device (source device) and a second device (receiving device). The source device may deliver encoded video/image information or data in the form of a file or streaming to the receiving device via a digital storage medium or network.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compression and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

This document relates to video/image coding. For example, the methods/embodiments disclosed in this document may be applied to a method disclosed in the versatile video coding (VVC), the EVC (essential video coding) standard, the AOMedia Video 1 (AV1) standard, the 2nd generation of audio video coding standard (AVS2), or the next generation video/image coding standard (ex. H.267 or H.268, etc.).

This document presents various embodiments of video/image coding, and the embodiments may be performed in combination with each other unless otherwise mentioned.

In this document, video may refer to a series of images over time. Picture generally refers to a unit representing one image in a specific time zone, and a slice/tile is a unit constituting part of a picture in coding. The slice/tile may include one or more coding tree units (CTUs). One picture may consist of one or more slices/tiles. One picture may consist of one or more tile groups. One tile group may include one or more tiles. A brick may represent a rectangular region of CTU rows within a tile in a picture. A tile may be partitioned into multiple bricks, each of which consisting of one or more CTU rows within the tile. A tile that is not partitioned into multiple bricks may be also referred to as a brick. A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture. A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consist of either a number of complete tiles or only a consecutive sequence of complete bricks of one tile. Tile groups and slices may be used interchangeably in this document. For example, in this document, a tile group/tile group header may be called a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows.

In this document, the term “/“and”,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

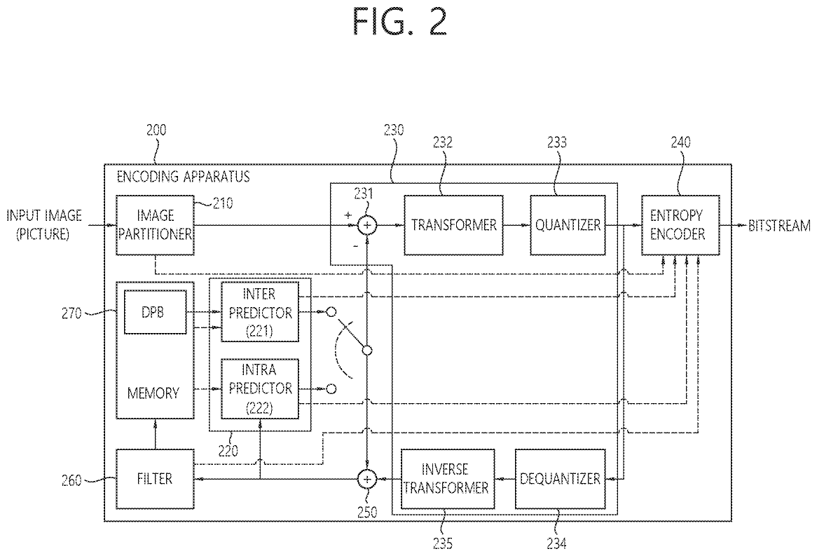

FIG. 2 is a schematic diagram illustrating a configuration of a video/image encoding apparatus to which the embodiment(s) of the present document may be applied. Hereinafter, the video encoding apparatus may include an image encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to this document may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in this document. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a karhunen-loeve transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In this document, information and/or syntax elements transmitted/signaled from the encoding apparatus to the decoding apparatus may be included in video/picture information. The video/image information may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus may be avoided and encoding efficiency may be improved.

The DPB of the memory 270 DPB may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

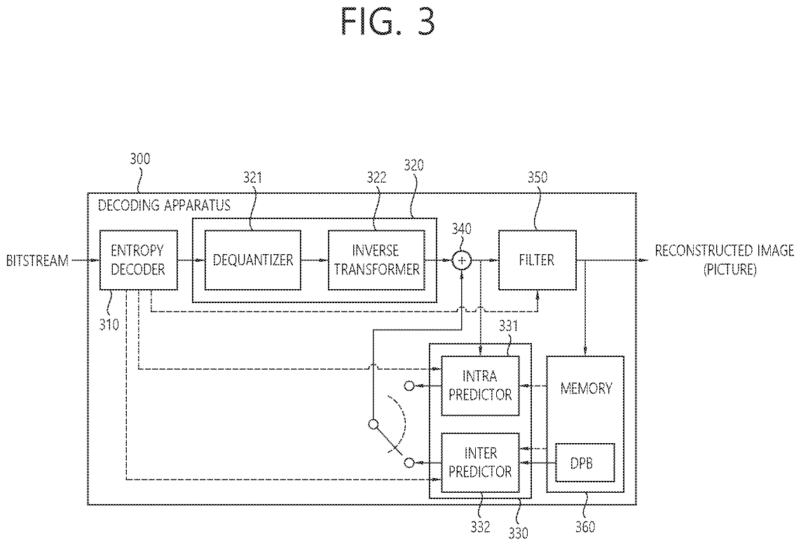

FIG. 3 is a schematic diagram illustrating a configuration of a video/image decoding apparatus to which the embodiment(s) of the present document may be applied.

Referring to FIG. 3, the decoding apparatus 300 may include an entropy decoder 310, a residual processor 320, a predictor 330, an adder 340, a filter 350, a memory 360. The predictor 330 may include an inter predictor 331 and an intra predictor 332. The residual processor 320 may include a dequantizer 321 and an inverse transformer 321. The entropy decoder 310, the residual processor 320, the predictor 330, the adder 340, and the filter 350 may be configured by a hardware component (ex. a decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in this document may be decoded through the decoding procedure, and may be obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to this document may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 310 and may determine a specific intra/inter prediction mode.

The predictor 320 may generate a prediction signal based on various prediction methods described below. For example, the predictor may not only apply intra prediction or inter prediction to predict one block but also simultaneously apply intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in this document. The palette mode may be considered as an example of intra coding or intra prediction. When the palette mode is applied, a sample value within a picture may be signaled based on information on the palette table and the palette index.

The intra predictor 331 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The intra predictor 331 may determine the prediction mode applied to the current block by using a prediction mode applied to a neighboring block.

The inter predictor 332 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 200 may be the same as or respectively applied to correspond to the filter 350, the inter predictor 332, and the intra predictor 331 of the decoding apparatus 300. The same may also apply to the unit 332 and the intra predictor 331.

Meanwhile, as described above, in performing video coding, a prediction is performed to enhance compression efficiency. Accordingly, a prediction block including prediction samples for a current block, that is, a coding target block, may be generated. In this case, the predicted block includes prediction samples in a spatial domain (or pixel domain). The prediction block is identically derived in the encoding apparatus and the decoding apparatus. The encoding apparatus may improve image coding efficiency by signaling residual information on a residual between an original block and the predicted block not an original sample value of the original block itself to the decoding apparatus. The decoding apparatus may derive a residual block including residual samples based on the residual information, may generate a reconstructed block including reconstructed samples by adding up the residual block and the prediction block, and may generate a reconstructed picture including the reconstructed block.

The residual information may be generated through a transform and quantization procedure. For example, the encoding apparatus may derive the residual block between the original block and the predicted block, may derive transform coefficients by performing a transform procedure on the residual samples (residual sample array) included in the residual block, may derive quantized transform coefficients by performing a quantization procedure on the transform coefficients, and may signal related residual information to the decoding apparatus (through a bit stream). In this case, the residual information may include information, such as value information, location information, a transform scheme, a transform kernel and a quantization parameter of the quantized transform coefficients. The decoding apparatus may perform a dequantization/inverse transform procedure based on the residual information and may derive the residual samples (or residual block). The decoding apparatus may generate the reconstructed picture based on the prediction block and the residual block. The encoding apparatus may also derive the residual block by performing a dequantization/inverse transform on the quantized transform coefficients for the reference of inter prediction of a subsequent picture and may generate the reconstructed picture based on the residual block.

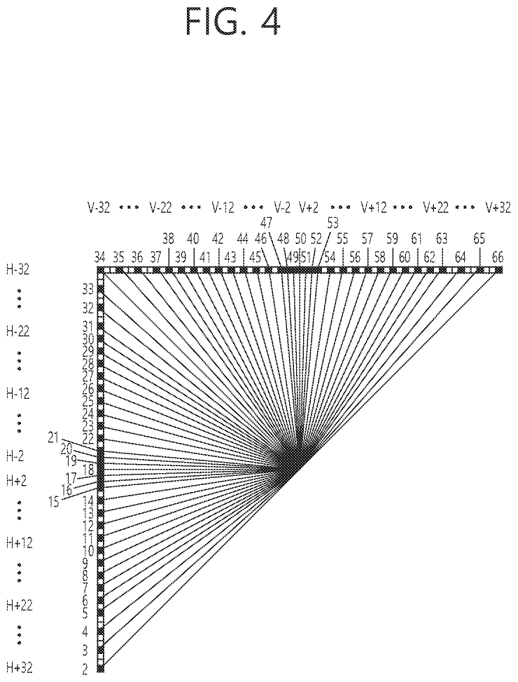

FIG. 4 illustrates intra-directional modes of 65 prediction directions.

Referring to FIG. 4, intra-prediction modes having horizontal directionality and intra-prediction modes having vertical directionality may be classified based on an intra-prediction mode #34 having an upper left diagonal prediction direction. H and V in FIG. 3 represent the horizontal directionality and the vertical directionality, respectively, and the numbers from −32 to 32 represent displacements of 1/32 unit on sample grid positions. Intra-prediction modes #2 to #33 have the horizontal directionality and intra-prediction modes #34 to #66 have the vertical directionality. Intra-prediction mode #18 and intra-prediction mode #50 represent a horizontal intra-prediction mode and a vertical intra-prediction mode, respectively. Intra-prediction mode #2 may be called a lower left diagonal intra-prediction mode, intra-prediction mode #34 may be called an upper left diagonal intra-prediction mode and intra-prediction mode #66 may be called an upper right diagonal intra-prediction mode.

Meanwhile, apart from the above-described intra prediction modes, the intra prediction mode may further include a cross-component linear model (CCLM) mode. The CCLM mode may be divided into LT_CCLM, L_CCLM, and T_CCLM depending upon whether the left samples are being considered, whether top samples are being considered, or whether both left samples and top samples are being considered in order to derive LM parameters. And, this/these may only be applied to the chroma components. According to an embodiment, the intra prediction modes may be indexed as shown below in the following Table.

TABLE 1

| Intra | |
|---|---|
| prediction mode | Associated name |
| 0 | INTRA_PLANAR |
| 1 | INTRA_DC |
| 2 . . . 66 | INTRA_ANGULAR2 . . . INTRA_ANGULAR66 |
| 81 . . . 83 | INTRA_LT_CCLM, INTRA_L_CCLM, |
| | INTRA_T_CCLM |

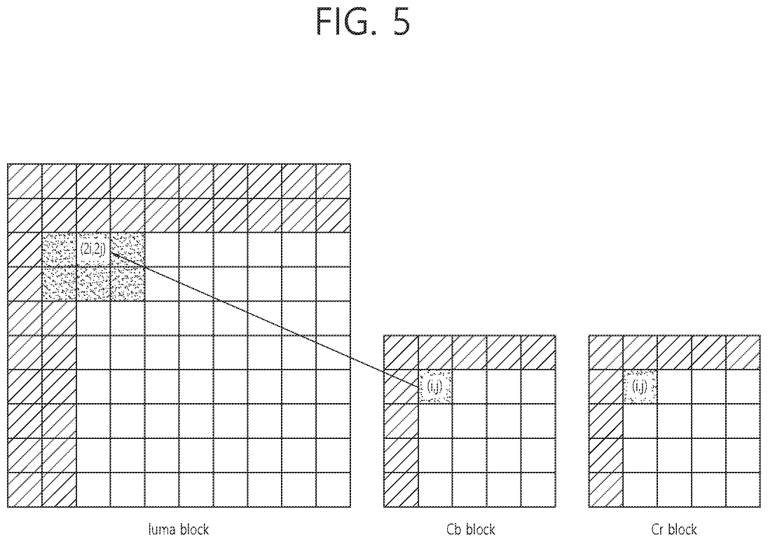

FIG. 5 is a diagram for describing a process of deriving an intra-prediction mode of a current chroma block according to an embodiment.

In the present disclosure, “chroma block”, “chroma image”, and the like may represent the same meaning of chrominance block, chrominance image, and the like, and accordingly, chroma and chrominance may be commonly used. Likewise, “luma block”, “luma image”, and the like may represent the same meaning of luminance block, luminance image, and the like, and accordingly, luma and luminance may be commonly used.

In the present disclosure, a “current chroma block” may mean a chroma component block of a current block, which is a current coding unit, and a “current luma block” may mean a luma component block of a current block, which is a current coding unit. Accordingly, the current luma block and the current chroma block correspond with each other. However, block formats and block numbers of the current luma block and the current chroma block are not always the same but may be different depending on a case. In some cases, the current chroma block may correspond to the current luma region, and in this case, the current luma region may include at least one luma block.

In the present disclosure, “reference sample template” may mean a set of reference samples neighboring a current chroma block for predicting the current chroma block. The reference sample template may be predefined, or information for the reference sample template may be signaled to the decoding apparatus 300 from the encoding apparatus 200.

Referring to FIG. 5, a set of samples one shaded line neighboring 4×4 block, which is a current chroma block, represents a reference sample template. It is shown in FIG. 5 that the reference sample template includes a reference sample of one line, but the reference sample region in a luma region corresponding to the reference sample template includes two lines.

In an embodiment, when an intra encoding of a chroma image is performed in Joint Exploration TEST Model (JEM) used in Joint Video Exploration Team (JVET), Cross Component Linear Model (CCLM) may be used. CCLM is a method of predicting a pixel value of a chroma image based on a pixel value of a reconstructed luma image, which is based on the property of high correlation between a chroma image and a luma image.

CCLM prediction of Cb and Cr chroma images may be based on the equation below.

Pred_{c}(i,j)=α·Rec′_{L}(i,j)+β [Equation 1]

Here, pred_{c} (i,j) means a Cb or Cr chroma image to be predicted, Rec_{L}′(i,j) means a reconstructed luma image of which the size is adjusted to a chroma block size, and (i,j) means pixel coordinates. In the 4:2:0 color format, since the size of the luma image is double the size of the chroma image, Rec_{L}′ of a chroma block size should be generated through downsampling, and thus pixels of the luma image to be used for the chroma image pred_{c} (i,j) may be used in consideration of all neighboring pixels in addition to Rec_{L}(2i,2j). The Rec_{L}′(i,j) may be represented as downsampled luma samples.

For example, the Rec_{L}′(i,j) may be derived using 6 neighboring pixels as in the following equation.

Rec′_{L}(x,y)=(2×Rec_{L}(2x,2y)+2×Rec_{L}(2x,2y+1)+Rec_{L}(2x−1.2y)+Rec_{L}(2x+1.2y)+Rec_{L}(2x−1.2y+1)+Rec_{L}(2x+1.2y+1)+4)>>3 [Equation 2]

Further, α and β represent a cross-correlation and an average value difference between a Cb or Cr chroma block neighboring template and a luma block neighboring template as shown as shaded regions of FIG. 5, and may be, for example, as in Equation 3 below.

$$a - \frac{N \cdot \sum ( L ( n ) \cdot C ( n ) ) - \sum L ( n ) \cdot \sum C ( n )}{N \cdot \sum ( L ( n ) \cdot L ( n ) ) - \sum L ( n ) \cdot \sum L ( n )} \\ β = \frac{\sum C ( n ) - α \cdot \sum L ( n )}{N} \qquad [ Equation 3 ]$$

Here, L(n) means neighboring reference samples and/or left neighboring samples of a luma block corresponding to a current chroma image, C(n) means neighboring reference samples and/or left neighboring samples of a current chroma block to which encoding is currently applied, and (i,j) means a pixel location. Further, L(n) may represent downsampled top neighboring samples and/or left neighboring samples of the current luma block. Further, N may represent the number of total pixel pair (luma and chroma) values used to calculate a CCLM parameter, and may represent a value that is twice as large as a smaller value between a width and a height of the current chroma block.

Meanwhile, samples for parameter calculation (e.g., α and β) for the above-described CCLM prediction may be selected as follows.
In the case that the current chroma block is a chroma block of N×N size, total 2N (N horizontal and N vertical) neighboring reference sample pairs (luma and chroma) of the current chroma block may be selected.
In the case that the current chroma block is a chroma block of N×M size or M×N size (here, N<=M), total 2N (N horizontal and N vertical) neighboring reference sample pairs of the current chroma block may be selected. Meanwhile, since M is larger than N (e.g., M=2N or 3N, and the like), N sample pairs may be selected through subsampling among M samples.

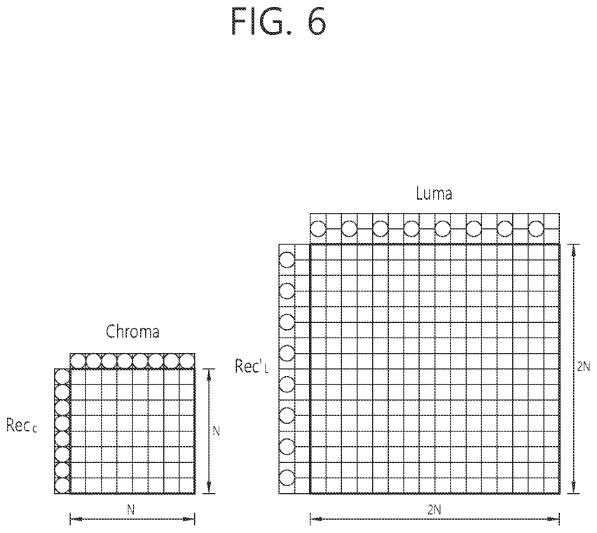

FIG. 6 illustrates 2N reference samples for parameter calculation for CCLM prediction described above. Referring to FIG. 6, 2N reference sample pairs are shown, which is derived for parameter calculation for the CCLM prediction. The 2N reference sample pairs may include 2N reference samples adjacent to the current chroma block and 2N reference samples adjacent to the current luma block.

Meanwhile, in order to perform intra chroma prediction coding, a total of 8 intra prediction modes may be allowed (or authorized) for intra chroma coding. The 8 intra prediction modes may include 5 conventional (or existing) intra prediction modes and CCLM mode(s). Table 1 shows a mapping table for intra chroma prediction mode derivation of a case where CCLM prediction is not available, and Table 2 shows a mapping table for intra chroma prediction mode derivation of a case where CCLM prediction is available.

As indicated in Table 2 and Table 3, the intra chroma prediction mode may be determined based on values of information on the intra luma prediction mode for the luma block (e.g., in a case where DUAL_TREE is applied), which covers the center bottom left sample of the current block or chroma block, and the signaled intra chroma prediction mode (intra_chroma_pred_mode). Indexes of IntraPredModeC[xCb] [yCb] being derived from Tables shown below may correspond to indexes of the intra prediction mode disclosed in the above-described Table 1.

TABLE 2

| | IntraPredModeY[xCb + | | | | |
|---|---|---|---|---|---|
| | cbWidth/2][yCb + cbHeight/2] | | | | |
| | | | | | X (0 <= |
| intra_chroma_pred_mode[xCb][yCb] | 0 | 50 | 18 | 1 | X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |

TABLE 3

| | IntraPredModeY[xCb + | | | | |
|---|---|---|---|---|---|
| | cbWidth/2][yCb + cbHeight/2] | | | | |
| | | | | | X (0 <= |
| intra_chroma_pred_mode[xCb][yCb] | 0 | 50 | 18 | 1 | X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 81 | 81 | 81 | 81 | 81 |
| 5 | 82 | 82 | 82 | 82 | 82 |
| 6 | 83 | 83 | 83 | 83 | 83 |
| 7 | 0 | 50 | 18 | 1 | X |

Hereinafter, intra prediction, more specifically, a method considering a color format of a coding block when performing CCLM prediction will be described in detail. Such prediction method may be performed by both an encoding apparatus and a decoding apparatus.

A color format may be a configuration format of a luma sample and a chroma sample (cb, cr), and this may also be referred to as a chroma format. The color format or chroma format may be predetermined or may be adaptively signaled. For example, the chroma format may be signaled based on at least of chroma_format_idc and separate_colour_plane_flag shown below in the following table.

TABLE 4

| chroma_for- | separate_col- | Chroma | | |
|---|---|---|---|---|
| mat_idc | our_plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

In monochrome sampling, there exists only one sample array, which is nominally (or generally) considered as a luma array. 4:2:0 sampling means that each of the two chroma arrays has half the height and half the width of the luma array. 4:2:2 sampling means that each of the two chroma arrays has half the width of the luma array and the same height as the luma array. And, 4:4:4 sampling means that each of the two chroma arrays has the same width and height as the luma array.

If separate_colour_plane_flag of Table 4 is equal to 0, this indicates that each of the two chroma arrays has the same height and width as the luma array. And, otherwise, i.e., if separate_colour_plane_flag is equal to 1, this indicates that the three colour planes are separately processed as monochrome sampled pictures.

The present embodiment relates to a method of performing CCLM prediction in a case where an input image has 4:2:2 and 4:4:4 color formats. And, herein, the case where the color format of an input image is 4:2:0 has been described above with reference to FIG. 5.

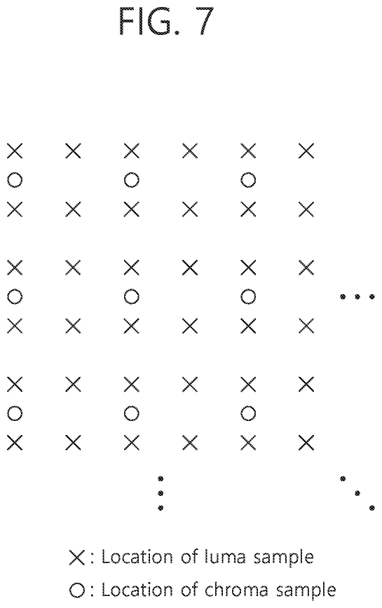

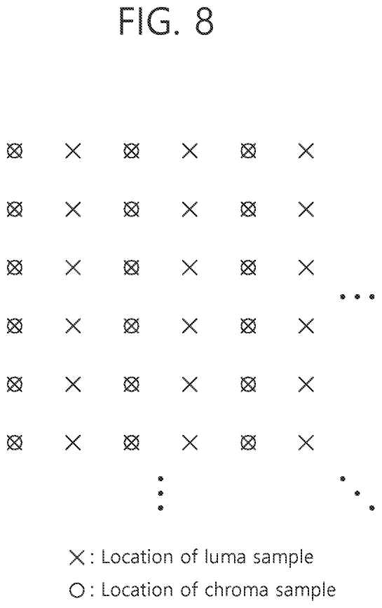

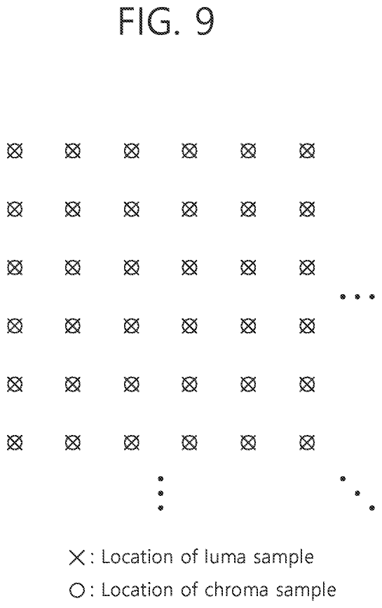

FIG. 7 to FIG. 9 illustrate positions of luma samples and chroma samples according to color formats. Herein, FIG. 7 illustrates vertical and horizontal positions of luma samples and chroma samples of 4:2:0 color format. FIG. 8 illustrates vertical and horizontal positions of luma samples and chroma samples of 4:2:2 color format. And, FIG. 9 illustrates vertical and horizontal positions of luma samples and chroma samples of 4:4:4 color format.

Unlike the 4:2:0 color format of FIG. 7, wherein the size of a luma image is two time the size of a chroma image, in the chroma image of the 4:2:2 color format shown in FIG. 8, the height of the chroma image is the same as the luma image, and the width of the chroma image is half the width of the luma image. Additionally, the chroma image of the 4:4:4 color format shown in FIG. 9 has the same size as the luma image. Such change in the image size is applied to both block-based image encoding and decoding.

As described above, in the 4:2:2 and 4:4:4 color format images, since downsampling using Equation 2 cannot be identically used, a different sampling method shall be performed for the CCLM prediction in the 4:2:2 and 4:4:4 color formats.

Accordingly, in the following embodiment, a method for performing CCLM prediction in 4:2:2 and 4:4:4 color formats will be proposed.

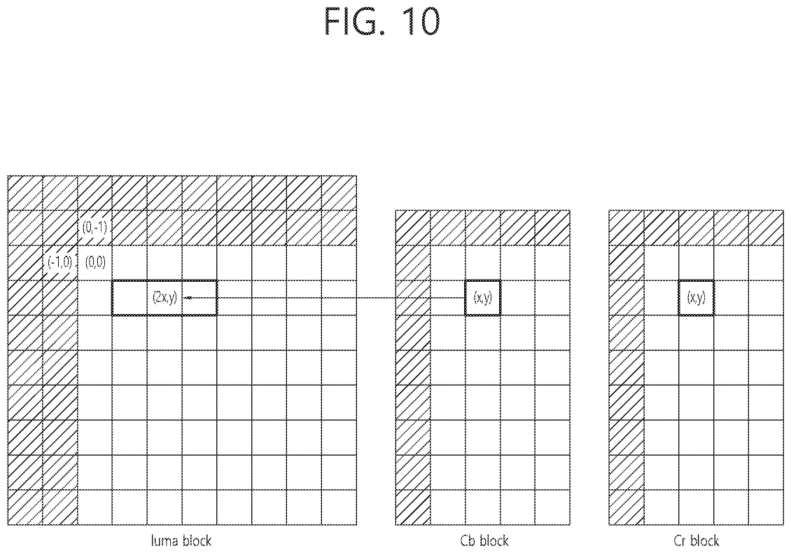

FIG. 10 is a diagram for describing CCLM prediction for a luma block and a chroma block in a 4:2:2 color format according to an embodiment of the present disclosure.

As shown in FIG. 10, in the 4:2:2 color format, since the height of the chroma block is the same as the luma block, and the width of the chroma block is half the width of the luma block, before performing the CCLM prediction according to Equation 1, the encoding apparatus and the decoding apparatus adjust the luma block by using the equation shown below, so that the size of the luma block is the same as the chroma block.

Rec′_{L}(x,y)=(2×Rec_{L}(2x,y)+Rec_{L}(2x−1,y)+Rec_{L}(2x+1,y)+2)>>2 [Equation 4]

In the equation presented above, Rec_{L} denotes a luma block, and Rec′_{L} denotes a luma block having downsampling applied thereto.

That is, since the height of the luma block is the same as the chroma block, only the width of the luma block needs to be downsampled to a 2:1 ratio.

In case of using reference samples of the current block in order to obtain CCLM parameters α and β, by performing downsampling on reference samples of the luma block, the encoding apparatus and the decoding apparatus equally matches the downsampled reference sample of the luma block with a reference sample region of the chroma block. Firstly, since a reference sample of the luma block corresponding to a left reference sample region of the chroma block is matched by 1:1 matching, a reference sample Rec_L (−1,y) corresponding to a height of the luma block may be expressed by using the equation shown below.

Rec′_{L}(1−,y)=Rec_{L}(−1,y) [Equation 5]

A reference sample of the luma block corresponding to a top reference sample region of the chroma block may be derived by performing 2:1 downsampling using the equation shown below.

Rec′_{L}(−1,y)=Rec_{L}(−1,y) [Equation 6]

After downsampling the luma block to the chroma block size by using Equation 4, the encoding apparatus and the decoding apparatus may perform CCLM prediction according to the conventional method. That is, the encoding apparatus and the decoding apparatus may calculate α and β by using comparison operation and linear mapping. Thereafter, the encoding apparatus and the decoding apparatus may perform CCLM prediction by using Equation 1.

Alternatively, according to an embodiment, when performing downsampling of the luma block through 6-tap filtering, as shown in Equation 2, by removing high-frequency components according to a low-frequency filtering effect, CCLM prediction accuracy may be enhanced. That is, the encoding apparatus and the decoding apparatus may perform downsampling on a luma block by using the following equation shown below.

Rec′_{L}(x,y)=(2×Rec_{L}(2x,y)+2×Rec_{L}(2x,y−1)+Rec_{L}(2x−1,y)+Rec_{L}(2x+1,y)+Rec_{L}(2x−1,y−1)+Rec_{L}(2x+1,y−1)+4)>>3 [Equation 7]

Additionally, reference samples of a luma block corresponding to a left reference sample region of a chroma block may be derived by using the following equation shown below.

Rec′_{L}(−1,y)=(2×Rec_{L}(−2,y)+2×Rec_{L}(−2,y−1)+Rec_{L}(−3,y)+Rec_{L}(−1,y)+Rec_{L}(−3,y−1)+Rec_{L}(−1,y−1)+4)>>3 [Equation 8]

Additionally, reference samples of a luma block corresponding to a top reference sample region of a chroma block may be derived by using the following equation shown below.

Rec′_{L}(x,−1)=(2×Rec_{L}(2x,−1)+2×Rec_{L}(2x,−2)+Rec_{L}(2x−1,−1)+Rec_{L}(2x+1,−1)+Rec_{L}(2x−1,−2)+Rec_{L}(2x+1,−2)+4)>>3 [Equation 9]

After downsampling the luma block to the chroma block size by using the equation presented above, the encoding apparatus and the decoding apparatus may perform CCLM prediction according to the conventional method. That is, the encoding apparatus and the decoding apparatus may calculate α and β by using comparison operation and linear mapping. Thereafter, the encoding apparatus and the decoding apparatus may perform CCLM prediction by using Equation 1.

In case of using the equation presented above, only one top line is used at a CTU boundary, just as in the conventional method, and, in case pixels exist in surrounding unavailable positions, filtering is performed while excluding such pixels.

As described above, CCLM prediction may also be performed in the 4:2:2 color format by using the method proposed in the present embodiment. Thus, compression efficiency of the 4:2:2 color format may be significantly enhanced.

Meanwhile, according to another embodiment, in case an image has a 4:4:4 color format, a method for performing CCLM prediction may be proposed. In case an image including the current block has a 4:4:4 color format, the encoding apparatus and the decoding apparatus may perform CCLM prediction as described below.

Firstly, before performing CCLM prediction according to Equation 1, the encoding apparatus and the decoding apparatus may adjust the luma block to match the chroma block size by using the following equation shown below.

Rec′_{L}(x,y)=Rec_{L}(x,y) [Equation 10]

In case of the 4:4:4 color format, sine the chroma block size is the same as the luma block size, downsampling of the luma block is not needed. And, accordingly, a Rec′_{L} block may be simply generated, as shown in Equation 10.

In case of using reference samples of the current block in order to obtain CCLM parameters α and β, since reference samples of the current block are the same as the reference sample region of the chroma block, the encoding apparatus and the decoding apparatus may derive left and top reference samples of the luma block by using the following equation shown below.

Rec′_{L}(−1,y)=Rec_{L}(−1,y)

Rec′_{L}(x,−1)=Rec_{L}(x,−1) [Equation 11]

After performing 1:1 matching of the luma block with the chroma block by using Equation 11, the encoding apparatus and the decoding apparatus may perform CCLM prediction according to the conventional method. That is, the encoding apparatus and the decoding apparatus may calculate α and β by using comparison operation and linear mapping. Thereafter, the encoding apparatus and the decoding apparatus may perform CCLM prediction by using Equation 1.

Alternatively, according to an embodiment, when performing downsampling of the luma block through 6-tap filtering, as shown in Equation 2, by removing high-frequency components according to a low-frequency filtering effect, CCLM prediction accuracy may be enhanced. That is, the encoding apparatus and the decoding apparatus may perform downsampling on a luma block by using the following equation shown below.

Rec′_{L}(x,y)=(5×Rec_{L}(x,y)+Rec_{L}(x,y−1)+Rec_{L}(x−1,y)+Rec_{L}(x+1,y)+Rec_{L}(x,y+1)+4)>>3 [Equation 12]

Additionally, reference samples of a luma block corresponding to a left reference sample region of a chroma block may be derived by using the following equation shown below.

Rec′_{L}(−1,y)=(2×Rec_{L}(−1,y)+Rec_{L}(−1,y−1)+Rec_{L}(−1,y+1)+2)>>2 [Equation 13]

Additionally, reference samples of a luma block corresponding to a top reference sample region of a chroma block may be derived by using the following equation shown below.

Rec′_{L}(x,−1)=(2×Rec_{L}(x,−1)+Rec_{L}(x−1,−1)+Rec_{L}(x+1,−1)+2)>>2 [Equation 14]

After filtering the luma block to the chroma block size by using the equation presented above, the encoding apparatus and the decoding apparatus may perform CCLM prediction according to the conventional method. That is, the encoding apparatus and the decoding apparatus may calculate α and β by using comparison operation and linear mapping. Thereafter, the encoding apparatus and the decoding apparatus may perform CCLM prediction by using Equation 1.

In case of using the equation presented above, only one top line is used at a CTU boundary, just as in the conventional method, and, in case pixels exist in surrounding unavailable positions, filtering is performed while excluding such pixels.

As described above, CCLM prediction may also be performed in the 4:4:4 color format by using the method proposed in the present embodiment. Thus, compression efficiency of the 4:4:4 color format may be significantly enhanced.

The methods for performing CCLM prediction in the 4:2:2 and 4:4:4 color formats, which are proposed in the present disclosure may be expressed as shown below in the following tables. The contents of Table 5 to Table 7 describe the embodiments proposed in the present disclosure in the standard document format, which is used in HEVC or VVC specification standards, and so on. And, herein, the image processing procedure and interpretations of the same, which are indicated in the detailed contents are apparent to anyone having ordinary skills in the art.

```
TABLE 5
Specifications of INTRA_LT_CCLM, INTRA_L_CCLM and INTRA_T_CCLM intra
prediction mode
  inputs [symbol]
  a sample location [symbol]
  in the top-left sample of thecurrent picture.

[symbol]

[symbol]

[symbol]

[symbol]




Output of this process

[symbol]

[symbol]

The current

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]














  The number of available top-right [symbol]
  follows:
  The variable

[symbol]

[symbol]

[symbol]


    The availability [symbol]  process for a block

[symbol]

[symbol]

[symbol]

[symbol]

[symbol]

[symbol]

[symbol]





    When [symbol]  is equal to TRUE, [symbol]  is [symbol]  by one.
  The number of available [symbol]
  follows:
  The [symbol]  is set equal to TRUE.
  When

[symbol]

[symbol]

    The

[symbol]

[symbol]

[symbol]

[symbol]



    When [symbol]
  The number of [symbol]  as
  follows:
    The variable [symbol]  is set equal to TRUE.
    When

[symbol]

[symbol]

[symbol]

[symbol]

[symbol]

[symbol]

[symbol]

[symbol]







  The number of available [symbol]
  follows: [symbol]
    The Variable [symbol]
    When

[symbol]

[symbol]

      The availablility

[symbol]

[symbol]

[symbol]

[symbol]



      When available

[symbol]

[symbol]

[symbol]

[symbol]



  If

[symbol]

[symbol]

[symbol]


  Otherwise, the following applies:

[symbol]

[symbol]

[symbol]

[symbol]

[symbol]

[symbol]






The variable [symbol]  is [symbol]  as follows:

[symbol]

[symbol]

[symbol]


indicates data missing or illegible when filed
```

Table 5 describes an intra prediction method in a case where the intra prediction mode of the current block is a CCLM mode. And, herein, an intra prediction mode, a top-left sample position of a current transform block, which is being viewed as the current block, width and height of a transform block, and neighboring reference samples of a chroma block are needed as input values. And, prediction samples may be derived by using output values based on the above-mentioned input values.

During this process, a process of checking availability of reference samples of the current block (wherein the variables availL, availT, and availTL are derived) may be performed, and, herein, a number of available top-right neighbouring chroma samples (numTopRight), a number of available left-below neighbouring chroma samples (numLeftBelow), a number of available neighbouring chroma samples on the top and top-right (numTopSamp) and a number of available neighbouring chroma samples on the left and left-below (nLeftSamp) may be derived.

```
TABLE 6
The [symbol]
follows:
  if both

[symbol]

[symbol]

[symbol]


  Otherwise, the following [symbol]  steps apply:
  1.

[symbol]

[symbol]

[symbol]


  2. The [symbol]
    When

[symbol]

[symbol]

[symbol]

[symbol]

[symbol]




      Otherwise the

[symbol]

[symbol]

        prior to the

[symbol]

[symbol]

[symbol]

[symbol]

[symbol]

[symbol]

[symbol]



    When

[symbol]

[symbol]

[symbol]

[symbol]

[symbol]




      Otherwise,

[symbol]

[symbol]

        prior to the

[symbol]

[symbol]

[symbol]

[symbol]

[symbol]

[symbol]

[symbol]



    When [symbol]  is equal to TRUE, the following applies:

[symbol]

[symbol]

[symbol]

[symbol]




      Otherwise, if

[symbol]

[symbol]

[symbol]

[symbol]

[symbol]

[symbol]

[symbol]

[symbol]

[symbol]

[symbol]






3. The

[symbol]

[symbol]

[symbol]

[symbol]

[symbol]

[symbol]

[symbol]

[symbol]

[symbol]

[symbol]









        If [symbol]  is equal to [symbol]
          follows:

[symbol]

[symbol]

[symbol]

[symbol]



        Otherwise,

[symbol]

[symbol]

[symbol]


        If [symbol]
          follows:

[symbol]

[symbol]

[symbol]

[symbol]



      Otherwise,

[symbol]

[symbol]

[symbol]


      If [symbol]
        as follows:

[symbol]

[symbol]

[symbol]



      Otherwise if [symbol]
        is [symbol]  as follows:

[symbol]

[symbol]


      Otherwise [symbol]
        is [symbol]  as follows:

[symbol]

[symbol]


      Otherwise
        is [symbol]  as follows:

[symbol]

    Otherwise, the following applies:

[symbol]

[symbol]

[symbol]

[symbol]




      If [symbol]
        follows:

[symbol]

[symbol]

[symbol]



      Otherwise,

[symbol]

[symbol]

    Otherwise, if [symbol]
      samples are [symbol]  as follows:

[symbol]

[symbol]

[symbol]



        If

[symbol]

[symbol]

[symbol]


        Otherwise,

[symbol]

[symbol]

    Otherwise, the following applies:

[symbol]

4. When

[symbol]

[symbol]

[symbol]

[symbol]

    If [symbol]
      are [symbol]
        If

[symbol]

[symbol]

[symbol]

[symbol]

[symbol]




        If

[symbol]

[symbol]

[symbol]

[symbol]



        Otherwise,

[symbol]

[symbol]

      Otherwise, the following applies:

[symbol]

[symbol]

[symbol]



    Otherwise, the following applies:

[symbol]

5. When

[symbol]

[symbol]

[symbol]

[symbol]

    If [symbol]
      are [symbol]  as follows:
        If

[symbol]

[symbol]

[symbol]

[symbol]

[symbol]

[symbol]

[symbol]






            Otherwise

[symbol]

[symbol]

[symbol]

[symbol]

[symbol]




            If [symbol]  is equal to FALSE, the
              following applies:

[symbol]

[symbol]

[symbol]



            Otherwise if [symbol]  is equal to TRUE and [symbol]
              the following applies:

[symbol]

[symbol]

[symbol]

[symbol]




            Otherwise if [symbol]
              FALSE, the following applies:

[symbol]

[symbol]


            Otherwise [symbol]
              the following applies:

[symbol]

    Otherwise, the following applies:

[symbol]

[symbol]

[symbol]

[symbol]

[symbol]

[symbol]






        Otherwise, [symbol]  the following applies:

[symbol]

[symbol]

[symbol]

[symbol]




        If [symbol]
          following applies:

[symbol]

[symbol]

[symbol]



        Otherwise if [symbol]
          the following applies:

[symbol]

[symbol]

[symbol]

[symbol]




        Otherwise [symbol]
          FALSE, the following applies:

[symbol]

        Otherwise [symbol]  ,
          the following applies:

[symbol]

  Otherwise if [symbol] [symbol]
    as follows:

[symbol]

[symbol]

[symbol]

[symbol]

[symbol]

[symbol]

[symbol]







Otherwise

[symbol]

[symbol]

  Otherwise, the following applies:

[symbol]

[symbol]

indicates data missing or illegible when filed
```

Table 6 describes a method for obtaining prediction samples for a chroma block and, most particularly, a process of deriving neighboring luma samples (2. The neighbouring luma samples samples pY[x][y] are derived), a process of deriving samples of a luma block corresponding to a chroma block for CCLM prediction, i.e., a process of downsampling luma block samples (3. The collocated luma samples pDsY[x][y] with x=0 . . . nTbW−1, y=O . . . nTbH−1 are derived), a process of deriving neighboring reference samples of a luma block, in case the number of left neighboring samples of an available luma block is greater than 0 (4. When numSampL is greater than 0, the neighbouring left luma samples pLeftDsY[y] with y=0 . . . numSampL−1 are derived), and a process of deriving neighboring reference samples of a luma block, in case the number of top neighboring samples of an available luma block is greater than 0 (5. When numSampT is greater than 0, the neighbouring top luma samples pTopDsY[x] with x=0 . . . numSampT−1 are specified).

In the process of deriving neighboring luma samples, if the number of left neighboring samples of an available luma block is greater than 0, and if the color format is 4:2:2 (wherein chroma_format_idc is equal to 2) or 4:4:4 (wherein chroma_format_idc is equal to 3), the left neighboring luma samples (x=−1, y=0 . . . numSampL−1) may be derived as recovered luma samples of a (xTbY+x, yTbY+y) position.

Additionally, in the process of deriving neighboring luma samples, if the number of top neighboring samples of an available luma block is greater than 0, and if the color format is 4:2:2, the top neighboring luma samples (x=0 . . . 2*numSampT−1, y=−1, −2) may be derived as recovered luma samples of a (xTbY+x, yTbY+y) position, and, if the color format is 4:4:4, the top neighboring luma samples (x=0 . . . numSampT−1, y=−1) may be derived as recovered luma samples of a (xTbY+x, yTbY+y) position.

Furthermore, in the process of deriving neighboring luma samples, if top-left reference samples of the current block are available, and if the color format is 4:2:2, top-left neighboring luma samples (x=−1, y=−1) may be derived as recovered luma samples of a (xTbY+x, yTbY+y) position.

In the process of downsampling luma block samples, if the color format is 4:2:2, the downsamples luma samples (pDsY[x][y] with x=1 . . . nTbW−1, y=0 . . . nTbH−1) may be derived by performing filtering on 3 luma samples (pDsY[x][y]=(pY[2*x−1][y]+2*pY[2*x][y]+pY[2*x+1][y]+2)>>2).

That is, in case the color format is 4:2:2, since the width of the luma block shall be reduced by half in accordance with the width of the chroma block, in order to derive a downsampled luma sample (x, y) value, samples ((2*x−1, y) and (2*x+1, y)) being located at left and right positions of the luma sample of a (2*x, y) position may be used. And, at this point, a filter coefficient may be 1:2:1.

In case the color format is 4:4:4, since the width of the luma block is the same as the width of the chroma block, the downsampled luma samples may be derived by using pDsY[xl][y]=pY[x][y].

Additionally, if left neighboring luma samples are available, the downsampled luma samples (pDsY[0][y] with y=0 . . . nTbH−1) may be derived by using pDsY[0][y]=(pY[−1][y]+2*pY[0][y]+pY[1][y]+2)>>2. And, if the left neighboring luma samples are not available, the downsampled luma samples may be derived by using pDsY[0][y]=pY[0][y.

That is, if left neighboring luma samples are available, luma samples located at the leftmost side of the luma block (0, y) may be filtered by using samples of (−1, y), (0, y), (1, y) positions. And, at this point, the filter coefficient may be 1:2:1.

Meanwhile, if the number of left neighboring samples of an available luma block is greater than 0, in the process of deriving neighboring reference samples of a luma block, if the color format is 4:2:2 or 4:4:4, the neighboring reference samples may be derived by using pLeftDsY[y]=pY[−1][y].

Since the height of the luma block is the same as the height of the chroma block, the left neighboring reference samples of the luma block may be derived without performing a downsampling process.

Meanwhile, if the number of top neighboring samples of an available luma block is greater than 0, in the process of deriving neighboring reference samples of a luma block, if the color format is 4:2:2 or 4:4:4, top neighboring luma reference samples (x=1 . . . numSampT−1) of a case where x=1 . . . numSampT−1 may be derived by using (pY[2*x−1][−1]+2*pY[2*x][−1]+pY[2*x+1][−1]+2)>>2.

That is, if top neighboring luma samples are available, since the width of the luma block shall be reduced by half in accordance with the width of the chroma block, in order to derive a downsampled top neighboring luma reference sample (x, y) value, samples ((2*x−1, −1) and (2*x+1, −1)) being located at left and right positions of the luma sample of a (2*x, −1) position may be used. And, at this point, the filter coefficient may be 1:2:1.

At this point, if the top-left reference of the current block is available, the top neighboring luma reference sample having the x value equal to 0 (pTopDsY[0]) may be derived by using (pY[−1][−1]+2*pY[0][−1]+pY[1][−1]+2)>>2. And, if the top-left reference of the current block is not available, the top neighboring luma reference sample having the x value equal to 0 (pTopDsY[0]) may be derived by using pY[0][−1].

If the number of top neighboring samples of an available luma block is greater than 0, in the process of deriving neighboring reference samples of a luma block, if the color format is 4:4:4, the neighboring reference samples may be derived by using pTopDsY [x]=pY[x][−1].

```
TABLE 7
6. The [symbol]  as follows:
  If

[symbol]

[symbol]

[symbol]

[symbol]

[symbol]

[symbol]

[symbol]






  Otherwise of [symbol]  the following applies: [symbol]
    = [symbol] [symbol]
    = 1 [symbol] [symbol]
    = 1 [symbol]
  Otherwise [symbol]  the following applies: [symbol]
    = [symbol] [symbol]
    = 1 [symbol] [symbol]
    = 1 [symbol]
7. The variables [symbol]  are [symbol]  as follows:
  The variable [symbol]
    equal [symbol]
      If [symbol]
        are [symbol]  as follows:

[symbol]

[symbol]

[symbol]



      If

[symbol]

[symbol]

[symbol]


  If [symbol]  is equal to TRUE, [symbol]
    are [symbol]
      If

[symbol]

[symbol]

[symbol]

[symbol]



8. The [symbol]  are [symbol]  as follows:
  If [symbol]  is equal to [symbol]
    k = 0 [symbol]
    a = 0 [symbol]
    b = [symbol]
  Otherwise, the following applies:

[symbol]

      If [symbol]  is not equal to [symbol]  , the following applies:

[symbol]

        x =

[symbol]

[symbol]

        x = [symbol]
        y = [symbol]
        s = [symbol]
        k = [symbol]
        a = [symbol]
        b =

[symbol]

[symbol]

[symbol]


      Otherwise [symbol]  the following applies:
        k = 0 [symbol]
        a = 0 [symbol]
        b = [symbol]
9. The prediction samples

[symbol]

[symbol]

[symbol]

[symbol]


indicates data missing or illegible when filed
```

Table 7 shows a process of deriving various variables (wherein the variables are nS, xS, Ys, wherein the variables are minY, maxY, minC and maxC, and wherein the variables are a, b, and k) for obtaining prediction samples of a chroma block according to positions of available reference samples in a CCLM mode (9. The prediction samples predSamples[x][y] with x=O . . . nTbW−1, y=0 . . . nTbH−1 are derived).

The following drawings have been prepared to explain specific examples of the present disclosure. Since names of specific devices described in the drawings and names of specific signal/message/field are exemplarily presented, the technical features of the present disclosure are not limited to the specific names used in the following drawings.

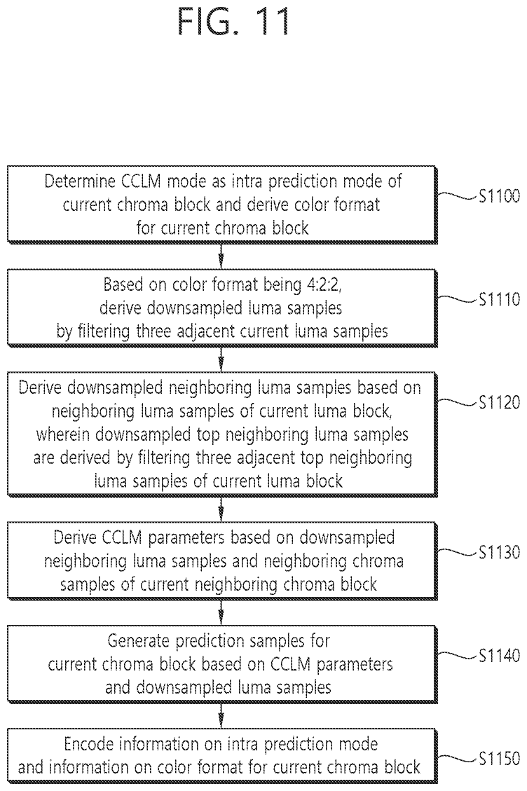

FIG. 11 schematically illustrates an image encoding method performed by an encoding apparatus according to the present document. The method disclosed in FIG. 11 may be performed by the encoding apparatus disclosed in FIG. 2. Specifically, for example, S1100 to S1140 in FIG. 11 may be performed by the predictor of the encoding apparatus, and S1150 may be performed by the entropy encoder of the encoding apparatus. Further, although not illustrated, a process of deriving residual samples for the current chroma block based on the original samples and prediction samples for the current chroma block may be performed by the subtractor of the encoding apparatus, and a process of deriving reconstructed samples for the current chroma block based on the residual samples and the prediction samples for the current chroma block may be performed by the adder of the encoding apparatus. A process of generating information on a residual for the current chroma block based on the residual samples may be performed by the transformer of the encoding apparatus, and a process of encoding the information on the residual may be performed by the entropy encoder of the encoding apparatus.

The encoding apparatus may determine a cross-component linear model (CCLM) mode as the intra prediction mode of the current chroma block and may derive a color format for the current chroma block (S1100).

For example, the encoding apparatus may determine the intra prediction mode for the current chroma block based on a rate-distortion (RD) cost (or RDO). Here, the RD cost may be derived based on the sum of absolute difference (SAD). The encoding apparatus may determine the CCLM mode as the intra prediction mode for the current chroma block based on the RD cost.

A color format may be a configuration format of a luma sample and a chroma sample (cb, cr), and this may also be referred to as a chroma format. The color format or chroma format may be predetermined or may be adaptively signaled. The color format of the current chroma block may be derived by using one of the five color formats shown in Table 4. And, the color format may be signaled based on at least of chroma_format_idc and separate_colour_plane_flag.

Further, the encoding apparatus may encode information on the intra prediction mode for the current chroma block, and the information on the intra prediction mode may be signaled through a bitstream. The prediction-related information of the current chroma block may include the information on the intra prediction mode.

The encoding apparatus may derive downsampled luma samples based on the current luma block, and, if the color format of the current chroma block is 4:2:2, the encoding apparatus may derive the downsampled luma samples by filtering 3 adjacent (or contiguous) current luma samples (S1110).

If the color format of the current chroma block is 4:2:2, as shown in FIG. 8, the encoding apparatus may perform downsampling, wherein the width of a luma block is reduced by half, as shown in FIG. 10. And, at this point, by filtering the 3 adjacent (or contiguous) current luma samples, the downsampled luma samples may be derived.

If coordinates of a downsampled luma sample is (x, y), coordinates of the 3 adjacent (or contiguous) first luma sample, second luma sample, and third luma sample may be (2x−1, y), (2x, y), and (2x+1, y), respectively. And, at this point, as shown in Equation 4, a 3-tap filter may be used. That is, a ratio of filter coefficients being applied to the first luma sample, the second luma sample, and the third luma sample may be 1:2:1.

Additionally, according to an example, the encoding apparatus may remove high-frequency components by using a low-frequency filtering effect when performing downsampling of a luma block. And, at this point, the downsampled luma sample may be derived by using Equation 7.

Meanwhile, if the color format of the current chroma block is 4:4:4, as shown in FIG. 9, the encoding apparatus may derive downsampled luma samples without performing filtering on samples of the current luma block as shown in Equation 10. That is, each luma sample of the current luma block may be respectively derived as a corresponding downsampled luma sample without filtering.

Additionally, according to an example, when deriving a downsampling luma sample, the encoding apparatus may remove high-frequency components by using a low-frequency filtering effect based on Equation 12.

The encoding apparatus may derive downsampled neighboring luma samples based on the neighboring luma samples of the current luma block and may derive downsampled top neighboring luma samples by filtering 3 adjacent (or contiguous) top neighboring luma samples of the current luma block (S1120).

Herein, the neighboring luma samples may be related samples corresponding to the top neighboring chroma samples and the left neighboring chroma samples. The downsampled neighboring luma samples may include downsampled top neighboring luma samples of the current luma block corresponding to the top neighboring chroma samples corresponding to the top neighboring chroma samples and downsampled left neighboring luma samples of the current luma block corresponding to the left neighboring chroma samples.

If the color format of the current chroma block is 4:2:2, a top reference sample region of the chroma block, i.e., reference samples of a luma block corresponding to the top neighboring chroma samples may be derived based on Equation 6.

As shown in Equation 6, if coordinates of a downsampled top neighboring luma sample is (x, y), coordinates of the 3 adjacent (or contiguous) first top neighboring luma sample, second top neighboring luma sample, and third top neighboring luma sample may be (2x−1, y), (2x, y), and (2x+1, y), respectively, and a ratio of filter coefficients being applied to the coordinates of the first top neighboring luma sample, the second top neighboring luma sample, and the third top neighboring luma sample may be 1:2:1.

Additionally, if the color format of the current chroma block is 4:2:2, a left reference sample region of the chroma block, i.e., reference samples of a luma block corresponding to the left neighboring chroma samples may be derived based on Equation 5.

Additionally, according to an embodiment, in order to remove the high-frequency components, filtering may be performed on the reference samples of a luma block, as shown in Equation 8 and Equation 9.

Meanwhile, if the color format of the current chroma block is 4:4:4, as shown in FIG. 9, the encoding apparatus may derive a top reference sample region of the chroma block, i.e., reference samples of a luma block corresponding to the top neighboring chroma samples, and a left reference sample region of the chroma block, i.e., reference samples of a luma block corresponding to the left neighboring chroma samples, as downsampled neighboring luma samples without performing filtering on the neighboring samples of the current luma block. That is, each of the neighboring luma samples may be derived as the downsampled neighboring luma samples without filtering. And, herein, if the coordinates of a downsampled top neighboring luma sample is (x, y), coordinates of a top neighboring luma sample may also be (x, y).

Meanwhile, according to an example, when deriving a downsampling neighboring luma sample, the encoding apparatus may remove high-frequency components using a low-frequency filtering effect based on Equation 13 and Equation 14.

Meanwhile, according to an example, the encoding apparatus may derive a threshold value for a neighboring luma sample, i.e., a neighboring reference sample of a luma block.

The threshold value may be derived to derive the CCLM parameters for the current chroma block.

For example, the threshold value may be represented as an upper limit of the number of neighboring samples, or the maximum number of neighboring samples. The derived threshold value may be 4. Further, the derived threshold value may be 4, 8, or 16.

If the current chroma block is in the top and left based CCLM mode, that is, if the current chroma block is in the top left based CCLM mode, the CCLM parameters may be derived based on top left downsampled neighboring luma samples and top left neighboring chroma samples, of which the number is equal to the threshold value. For example, if the current chroma block is in the top left based CCLM mode and the threshold value is 4, the CCLM parameters may be derived based on two downsampled left neighboring luma samples, two downsampled top neighboring luma samples, two left neighboring chroma samples, and two top neighboring chroma samples.

Alternatively, if the current chroma block is in the left based CCLM mode, the parameters may be derived based on the left downsampled neighboring luma samples and the left neighboring chroma samples, of which the number is equal to the threshold value. For example, if the current chroma block is in the left based CCLM mode and the threshold value is 4, the CCLM parameters may be derived based on four downsampled left neighboring luma samples and four left neighboring chroma samples.

Alternatively, if the current chroma block is in the top based CCLM mode, the parameters may be derived based on the top downsampled neighboring luma samples and the top neighboring chroma samples, of which the number is equal to the threshold value. For example, if the current chroma block is in the top based CCLM mode and the threshold value is 4, the CCLM parameters may be derived based on four downsampled top neighboring luma samples and four top neighboring chroma samples.

The threshold value described above may be derived as a predetermined value. That is, the threshold value may be derived as a promised value between the encoding apparatus and the decoding apparatus. In other words, the threshold value may be derived as the predetermined value for the current chroma block to which the CCLM mode is applied.

Alternatively, for example, the encoding apparatus may encode image information including prediction-related information, and perform signaling of the image information including the prediction-related information through the bitstream, and the prediction-related information may include information indicating the threshold value. The information indicating the threshold value may be signaled in a unit of coding unit (CU), slice, PPS, or SPS.

The encoding apparatus may derive the top neighboring chroma samples of which the number is equal to the threshold value of the current chroma value, or the left neighboring chroma samples of which the number is equal to the threshold value, or the top neighboring chroma and left neighboring chroma samples of which the number is equal to the threshold value.

If the top neighboring chroma samples of which the number is equal to the threshold value are derived, the downsampled top neighboring luma samples of which the number is equal to the threshold value corresponding to the top neighboring chroma samples may be derived. Further, if the top neighboring chroma samples of which the number is equal to the value of the width are derived, the downsampled top neighboring luma samples of which the number is equal to the value of the width corresponding to the top neighboring chroma samples may be derived.

Further, if the left neighboring chroma samples of which the number is equal to the threshold value are derived, the downsampled left neighboring luma samples of which the number is equal to the threshold value corresponding to the left neighboring chroma samples may be derived. Further, if the left neighboring chroma samples, of which the number is equal to the value of the height, are derived, the downsampled left neighboring luma samples, of which the number is equal to the value of the height, corresponding to the left neighboring chroma samples may be derived.

If the top neighboring chroma samples and the left neighboring chroma samples, of which the number is equal to the threshold value are derived, the downsampled top neighboring luma samples and the left neighboring luma samples, of which the number is equal to the threshold value, corresponding to the top neighboring chroma samples and the left neighboring chroma samples may be derived.

Meanwhile, the samples which are not used to derive the downsampled neighboring luma samples among the neighboring luma samples of the current luma block may not be downsampled.

The encoding apparatus derives the CCLM parameters based on the threshold value, neighboring chroma samples including at least one of the top neighboring chroma samples and the left neighboring chroma samples, and the neighboring luma samples including at least one of the downsampled neighboring luma samples and the downsampled left neighboring luma samples (S1130).

The encoding apparatus may derive the CCLM parameters based on the threshold value, the top neighboring chroma samples, the left neighboring chroma samples, and the downsampled neighboring luma samples. For example, the CCLM parameters may be derived based Equation 3 as described above.

The encoding apparatus derives the prediction samples for the current chroma block based on the CCLM parameters and the downsampled luma samples (S1140).

The encoding apparatus may derive the prediction samples for the current chroma block based on the CCLM parameters and the downsampled luma samples. The encoding apparatus may generate the prediction samples for the current chroma block by applying the CCLM being derived from the CCLM parameters to the downsampled luma samples. That is, the encoding apparatus may generate the prediction samples for the current chroma block by performing the CCLM prediction based on the CCLM parameters. For example, the prediction samples may be derived based on Equation 1 as described above.

The encoding apparatus encodes prediction related information for the current chroma block, i.e., information on an intra prediction mode and image information including information on a color format for the current chroma block (S1150).

The encoding apparatus may encode the image information including the prediction-related information for the current chroma block, and perform signaling of the image information through the bitstream.

For example, the prediction-related information may further include information indicating the threshold value. Alternatively, for example, the prediction-related information may include the information indicating the specific threshold value. Alternatively, for example, the prediction-related information may include the flag information indicating whether to derive the number of neighboring reference samples based on the threshold value. Alternatively, for example, the prediction-related information may include the information indicating the intra prediction mode for the current chroma block.

Meanwhile, although not illustrated, the encoding apparatus may derive the residual samples for the current chroma block based on the original samples and prediction samples for the current chroma block, generate information on the residual for the current chroma block based on the residual samples, and encode the information on the residual. The image information may include information on the residual. Further, the encoding apparatus may generate the reconstructed samples for the current chroma block based on the prediction samples and the residual samples for the current chroma block.

Meanwhile, the bitstream may be transmitted to the decoding apparatus through a network or (digital) storage medium. Here, the network may include a broadcasting network and/or a communication network, and the digital storage medium may include various storage media, such as USB, SD, CD, DVD, Blu-ray, HDD, and SSD.

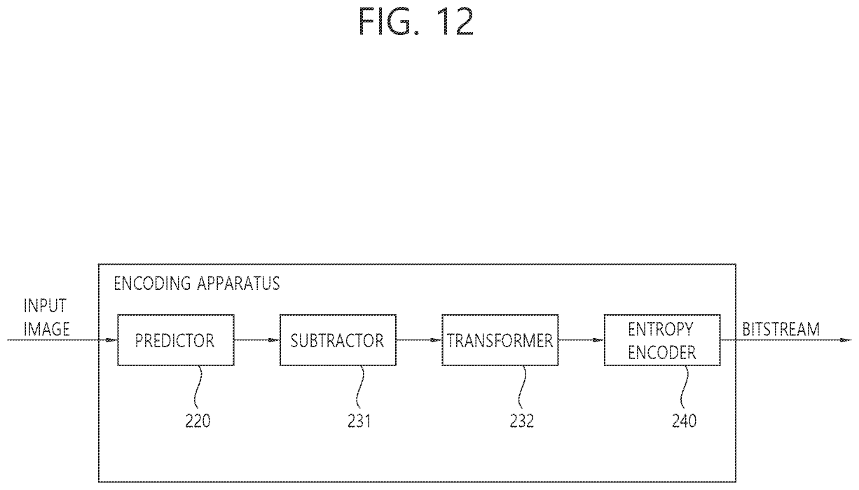

FIG. 12 schematically illustrates an encoding apparatus for performing an image encoding method according to the present document. The method disclosed in FIG. 11 may be performed by the encoding apparatus disclosed in FIG. 12. Specifically, for example, the predictor of the encoding apparatus of FIG. 12 may perform S1100 to S1140 in FIG. 11, and the entropy encoder of the encoding apparatus of FIG. 12 may perform S1150 of FIG. 11. Further, although not illustrated, the process of deriving the residual samples for the current chroma block based on the original samples and prediction samples for the current chroma block may be performed by the subtractor of the encoding apparatus of FIG. 12, and the process of deriving the reconstructed samples for the current chroma block based on the prediction samples and the residual samples for the current chroma block may be performed by the adder of the encoding apparatus of FIG. 12. The process of generating the information on the residual for the current chroma block based on the residual samples may be performed by the transformer of the encoding apparatus of FIG. 12, and the process of encoding the information on the residual may be performed by the entropy encoder of the encoding apparatus of FIG. 12.

The following drawings have been prepared to explain specific examples of the present disclosure. Since names of specific devices described in the drawings and names of specific signal/message/field are exemplarily presented, the technical features of the present disclosure are not limited to the specific names used in the following drawings.

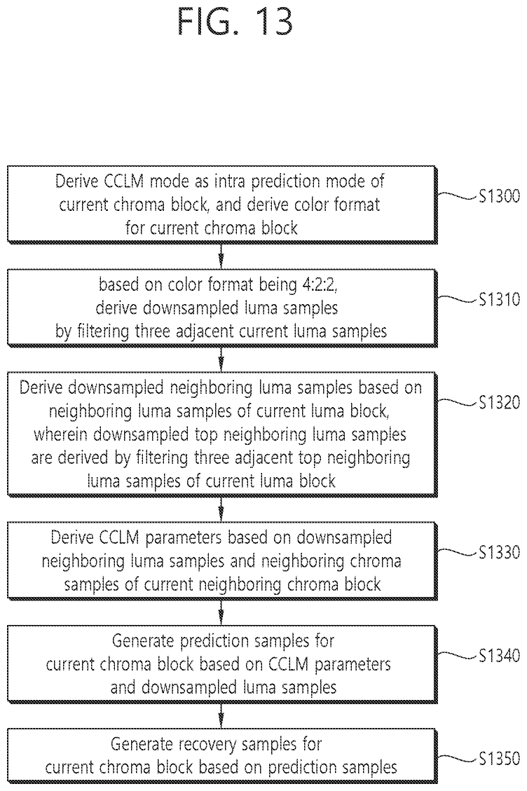

FIG. 13 schematically illustrates an image decoding method performed by a decoding apparatus according to the present document. The method disclosed in FIG. 13 may be performed by the decoding apparatus disclosed in FIG. 3. Specifically, for example, S1300 to S1340 in FIG. 13 may be performed by the predictor of the decoding apparatus, and S1350 may be performed by the adder of the decoding apparatus. Further, although not illustrated, a process of acquiring information on the residual of the current block through the bitstream may be performed by the entropy decoder of the decoding apparatus, and a process of deriving the residual samples for the current block based on the residual information may be performed by the inverse transformer of the decoding apparatus.

The decoding apparatus may derive a cross-component linear model (CCLM) mode as the intra prediction mode of the current chroma block and may derive a color format for the current chroma block (S1300).

The decoding apparatus may receive and decode image information including information related to prediction of the current chroma block.

An intra prediction mode of the current chroma intra prediction mode and information on a color format may be derived. For example, the decoding apparatus may receive information on an intra prediction mode and information on a color format of the current chroma block through a bitstream, and the decoding apparatus may derive the CCLM mode as the intra prediction mode of the current chroma block based on the information on an intra prediction mode and the information on a color format.

A color format may be a configuration format of a luma sample and a chroma sample (cb, cr), and this may also be referred to as a chroma format. The color format or chroma format may be predetermined or may be adaptively signaled. The color format of the current chroma block may be derived by using one of the five color formats shown in Table 4. And, the color format may be signaled based on at least of chroma_format_idc and separate_colour_plane_flag.

Additionally, prediction related information may further include information indicating the threshold value. Additionally, for example, the prediction related information may include information indicating a specific threshold value. Additionally, for example, the prediction related information may include flag information indicating whether or not a number of neighboring reference samples are being derived based on the threshold value.

The decoding apparatus may derive downsampled luma samples based on the current luma block, and, if the color format of the current chroma block is 4:2:2, the encoding apparatus may derive the downsampled luma samples by filtering 3 adjacent (or contiguous) current luma samples (S1310).

If the color format of the current chroma block is 4:2:2, as shown in FIG. 8, the decoding apparatus may perform downsampling, wherein the width of a luma block is reduced by half, as shown in FIG. 10. And, at this point, by filtering the 3 adjacent (or contiguous) current luma samples, the downsampled luma samples may be derived.

If coordinates of a downsampled luma sample is (x, y), coordinates of the 3 adjacent (or contiguous) first luma sample, second luma sample, and third luma sample may be (2x−1, y), (2x, y), and (2x+1, y), re spectively. And, at this point, as shown in Equation 4, a 3-tap filter may be used. That is, a ratio of filter coefficients being applied to the first luma sample, the second luma sample, and the third luma sample may be 1:2:1.

Additionally, according to an example, the decoding apparatus may remove high-frequency components by using a low-frequency filtering effect when performing downsampling of a luma block. And, at this point, the downsampled luma sample may be derived by using Equation 7.

Meanwhile, if the color format of the current chroma block is 4:4:4, as shown in FIG. 9, the decoding apparatus may derive downsampled luma samples without performing filtering on samples of the current luma block as shown in Equation 10. That is, each luma sample of the current luma block may be respectively derived as a corresponding downsampled luma sample without filtering.

Additionally, according to an example, when deriving a downsampling luma sample, the decoding apparatus may remove high-frequency components by using a low-frequency filtering effect based on Equation 12.

The decoding apparatus may derive downsampled neighboring luma samples based on the neighboring luma samples of the current luma block and may derive downsampled top neighboring luma samples by filtering 3 adjacent (or contiguous) top neighboring luma samples of the current luma block (S1320).

Herein, the neighboring luma samples may be related samples corresponding to the top neighboring chroma samples and the left neighboring chroma samples. The downsampled neighboring luma samples may include downsampled top neighboring luma samples of the current luma block corresponding to the top neighboring chroma samples corresponding to the top neighboring chroma samples and downsampled left neighboring luma samples of the current luma block corresponding to the left neighboring chroma samples.

If the color format of the current chroma block is 4:2:2, a top reference sample region of the chroma block, i.e., reference samples of a luma block corresponding to the top neighboring chroma samples may be derived based on Equation 6.

As shown in Equation 6, if coordinates of a downsampled top neighboring luma sample is (x, y), coordinates of the 3 adjacent (or contiguous) first top neighboring luma sample, second top neighboring luma sample, and third top neighboring luma sample may be (2x−1, y), (2x, y), and (2x+1, y), respectively, and a ratio of filter coefficients being applied to the coordinates of the first top neighboring luma sample, the second top neighboring luma sample, and the third top neighboring luma sample may be 1:2:1.

Additionally, if the color format of the current chroma block is 4:2:2, a left reference sample region of the chroma block, i.e., reference samples of a luma block corresponding to the left neighboring chroma samples may be derived based on Equation 5.

Additionally, according to an embodiment, in order to remove the high-frequency components, filtering may be performed on the reference samples of a luma block, as shown in Equation 8 and Equation 9.

Meanwhile, if the color format of the current chroma block is 4:4:4, as shown in FIG. 9, the decoding apparatus may derive a top reference sample region of the chroma block, i.e., reference samples of a luma block corresponding to the top neighboring chroma samples, and a left reference sample region of the chroma block, i.e., reference samples of a luma block corresponding to the left neighboring chroma samples, as downsampled neighboring luma samples without performing filtering on the neighboring samples of the current luma block. That is, each of the neighboring luma samples may be derived as the downsampled neighboring luma samples without filtering. And, herein, if the coordinates of a downsampled top neighboring luma sample is (x, y), coordinates of a top neighboring luma sample may also be (x, y).

Meanwhile, according to an example, when deriving a downsampling neighboring luma sample, the decoding apparatus may remove high-frequency components using a low-frequency filtering effect based on Equation 13 and Equation 14.

Meanwhile, according to an example, the decoding apparatus may derive a threshold value for a neighboring luma sample, i.e., a neighboring reference sample of a luma block.

The threshold value may be derived to derive the CCLM parameters for the current chroma block.

For example, the threshold value may be represented as an upper limit of the number of neighboring samples, or the maximum number of neighboring samples. The derived threshold value may be 4. Further, the derived threshold value may be 4, 8, or 16.

If the current chroma block is in the top and left based CCLM mode, that is, if the current chroma block is in the top left based CCLM mode, the CCLM parameters may be derived based on top left downsampled neighboring luma samples of which the number is equal to the threshold value and top left neighboring chroma samples. For example, if the current chroma block is in the top left based CCLM mode and the threshold value is 4, the CCLM parameters may be derived based on two downsampled left neighboring luma samples, two downsampled top neighboring luma samples, two left neighboring chroma samples, and two top neighboring chroma samples.

Alternatively, if the current chroma block is in the left based CCLM mode, the parameters may be derived based on the left downsampled neighboring luma samples and the left neighboring chroma samples, of which the number of equal to the threshold value. For example, if the current chroma block is in the left based CCLM mode and the threshold value is 4, the CCLM parameters may be derived based on four downsampled left neighboring luma samples and four left neighboring chroma samples.

Alternatively, if the current chroma block is in the top based CCLM mode, the parameters may be derived based on the top downsampled neighboring luma samples and the top neighboring chroma samples, of which the number is equal to the threshold value. For example, if the current chroma block is in the top based CCLM mode and the threshold value is 4, the CCLM parameters may be derived based on four downsampled top neighboring luma samples and four top neighboring chroma samples.

The threshold value described above may be derived as a predetermined value. That is, the threshold value may be derived as a promised value between the encoding apparatus and the decoding apparatus. In other words, the threshold value may be derived as the predetermined value for the current chroma block to which the CCLM mode is applied.

Alternatively, for example, the decoding apparatus may receive image information including prediction related information through a bitstream, and the prediction related information may include information indicating the threshold value. The information indicating the threshold value may be signaled in units of coding unit (CU), slice, PPS, and SPS.

The decoding apparatus may derive the top neighboring chroma samples of which the number is equal to the threshold value of the current chroma value, or the left neighboring chroma samples of which the number is equal to the threshold value, or the top neighboring chroma and left neighboring chroma samples of which the number is equal to the threshold value.

If the top neighboring chroma samples of which the number is equal to the threshold value are derived, the downsampled top neighboring luma samples of which the number is equal to the threshold value corresponding to the top neighboring chroma samples may be derived. Further, if the top neighboring chroma samples of which the number is equal to the value of the width are derived, the downsampled top neighboring luma samples of which the number is equal to the value of the width corresponding to the top neighboring chroma samples may be derived.

Further, if the left neighboring chroma samples of which the number is equal to the threshold value are derived, the downsampled left neighboring luma samples of which the number is equal to the threshold value corresponding to the left neighboring chroma samples may be derived. Further, if the left neighboring chroma samples, of which the number is equal to the value of the height, are derived, the downsampled left neighboring luma samples, of which the number is equal to the value of the height, corresponding to the left neighboring chroma samples may be derived.

If the top neighboring chroma samples and the left neighboring chroma samples, of which the number is equal to the threshold value, are derived, the downsampled top neighboring luma samples and the left neighboring luma samples, of which the number is equal to the threshold value, corresponding to the top neighboring chroma samples and the left neighboring chroma samples may be derived.

Meanwhile, the samples which are not used to derive the downsampled neighboring luma samples among the neighboring luma samples of the current luma block may not be downsampled.

The decoding apparatus derives the CCLM parameters based on the threshold value, neighboring chroma samples including at least one of the top neighboring chroma samples and the left neighboring chroma samples, and neighboring luma samples including at least one of the downsampled neighboring luma samples and the downsampled left neighboring luma samples (S1330).

The decoding apparatus may derive the CCLM parameters based on the threshold value, the top neighboring chroma samples, the left neighboring chroma samples, and the downsampled neighboring luma samples. For example, the CCLM parameters may be derived based Equation 3 as described above.

The decoding apparatus derives prediction samples for the current chroma block based on the CCLM parameters and the down-sampled luma samples (S1340).

The decoding apparatus may derive the prediction samples for the current chroma block based on the CCLM parameters and the down-sampled luma samples. The decoding apparatus may apply the CCLM derived by the CCLM parameters to the own-sampled luma samples and generate prediction samples for the current chroma block. That is, the decoding apparatus may perform a CCLM prediction based on the CCLM parameters and generate prediction samples for the current chroma block. For example, the prediction samples may be derived based on Equation 1 described above.

The decoding apparatus generates reconstructed samples for the current chroma block based on the prediction samples (S1350).

The decoding apparatus may generate the reconstructed samples based on the prediction samples. For example, the decoding apparatus may receive information for a residual for the current chroma block from the bitstream. The information for the residual may include a transform coefficient for the (chroma) residual sample. The decoding apparatus may derive the residual sample (or residual sample array) for the current chroma block based on the residual information. In this case, the decoding apparatus may generate the reconstructed samples based on the prediction samples and the residual samples. The decoding apparatus may derive a reconstructed block or a reconstructed picture based on the reconstructed sample. Later, the decoding apparatus may apply the in-loop filtering procedure such as deblocking filtering and/or SAO process to the reconstructed picture to improve subjective/objective image quality, as described above.

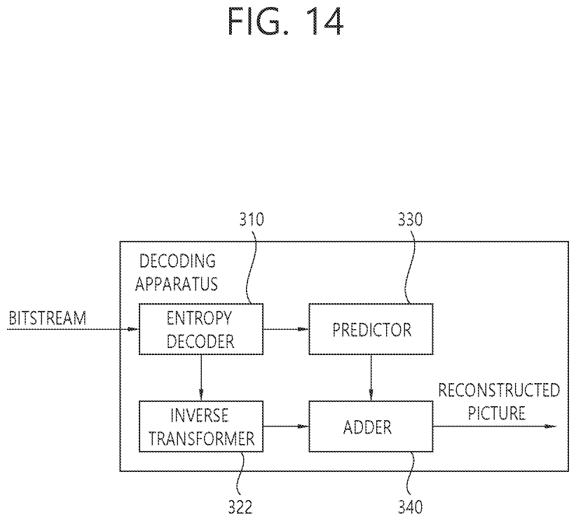

FIG. 14 schematically illustrates a decoding apparatus for performing an image decoding method according to the present document. The method disclosed in FIG. 13 may be performed by the decoding apparatus disclosed in FIG. 14. Specifically, for example, the predictor of the decoding apparatus of FIG. 14 may perform S1300 to S1340 of FIG. 13, and the adder of the decoding apparatus of FIG. 14 may perform S1350 in FIG. 13. Further, although not illustrated, the process of acquiring image information including information on the residual of the current block through the bitstream may be performed by the entropy decoder of the decoding apparatus of FIG. 14, and the process of deriving the residual samples for the current block based on the residual information may be performed by the inverse transformer of the decoding apparatus of FIG. 14.

According to the present document as described above, the image coding efficiency can be enhanced through performing of the intra prediction based on the CCLM.

Further, according to the present document, the CCLM-based intra prediction efficiency can be enhanced.

Further, according to the present document, the intra prediction complexity can be reduced by limiting the number of neighboring samples being selected to derive the linear model parameter for the CCLM to the specific number.

In the above-described embodiment, the methods are described based on the flowchart having a series of steps or blocks. The present disclosure is not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The embodiments described in this specification may be performed by being implemented on a processor, a microprocessor, a controller or a chip. For example, the functional units shown in each drawing may be performed by being implemented on a computer, a processor, a microprocessor, a controller or a chip. In this case, information for implementation (e.g., information on instructions) or algorithm may be stored in a digital storage medium.

In addition, the decoding device and the encoding device to which the present disclosure is applied may be included in a multimedia broadcasting transmission/reception apparatus, a mobile communication terminal, a home cinema video apparatus, a digital cinema video apparatus, a surveillance camera, a video chatting apparatus, a real-time communication apparatus such as video communication, a mobile streaming apparatus, a storage medium, a camcorder, a VoD service providing apparatus, an Over the top (OTT) video apparatus, an Internet streaming service providing apparatus, a three-dimensional (3D) video apparatus, a teleconference video apparatus, a transportation user equipment (e.g., vehicle user equipment, an airplane user equipment, a ship user equipment, etc.) and a medical video apparatus and may be used to process video signals and data signals. For example, the Over the top (OTT) video apparatus may include a game console, a blue-ray player, an internet access TV, a home theater system, a smart phone, a tablet PC, a Digital Video Recorder (DVR), and the like.

Furthermore, the processing method to which the present disclosure is applied may be produced in the form of a program that is to be executed by a computer and may be stored in a computer-readable recording medium. Multimedia data having a data structure according to the present disclosure may also be stored in computer-readable recording media. The computer-readable recording media include all types of storage devices in which data readable by a computer system is stored. The computer-readable recording media may include a BD, a Universal Serial Bus (USB), ROM, PROM, EPROM, EEPROM, RAM, CD-ROM, a magnetic tape, a floppy disk, and an optical data storage device, for example. Furthermore, the computer-readable recording media includes media implemented in the form of carrier waves (e.g., transmission through the Internet). In addition, a bit stream generated by the encoding method may be stored in a computer-readable recording medium or may be transmitted over wired/wireless communication networks.

In addition, the embodiments of the present disclosure may be implemented with a computer program product according to program codes, and the program codes may be performed in a computer by the embodiments of the present disclosure. The program codes may be stored on a carrier which is readable by a computer.

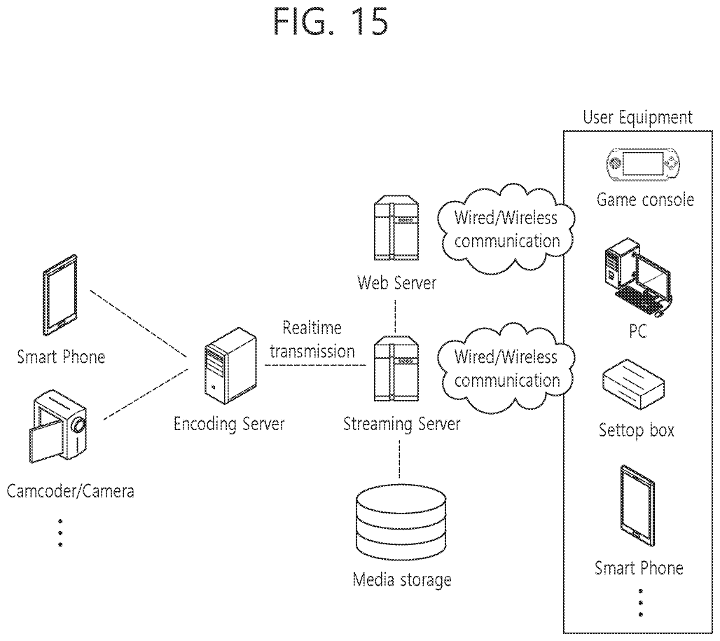

FIG. 15 illustrates a structural diagram of a contents streaming system to which the present disclosure is applied.

The content streaming system to which the embodiment(s) of the present document is applied may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present document is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. smartwatches, smart glasses, head mounted displays), digital TVs, desktops computer, digital signage, and the like. Each server in the content streaming system may be operated as a distributed server, in which case data received from each server may be distributed.

Claims described in the present disclosure may be combined in various ways. For example, the technical features of the method claims of the present disclosure may be combined to be implemented as the apparatus, and the technical features of the apparatus claims of the present disclosure may be combined to be implemented as the method. Further, the technical features of the method claims and the technical features of the apparatus claims of the present disclosure may be combined to be implemented as the apparatus, and the technical features of the method claims and the technical features of the apparatus claims of the present disclosure may be combined to be implemented as the method.

What is claimed is:

1. An image decoding method performed by a decoding apparatus, the method comprising:
deriving a cross-component linear model (CCLM) mode as an intra prediction mode of a current chroma block based on prediction mode information for the current chroma block, and deriving a color format for the current chroma block;
deriving downsampled luma samples based on a current luma block;
deriving downsampled neighboring luma samples based on neighboring luma samples of the current luma block;
deriving CCLM parameters based on the downsampled neighboring luma samples and neighboring chroma samples of a current neighboring chroma block; and
generating prediction samples for the current chroma block based on the CCLM parameters and the downsampled luma samples,
wherein the downsampled luma samples are derived by filtering three adjacent current luma samples if the color format is 4:2:2.

2. The method of claim 1, wherein if coordinates of a downsampled luma sample is (x, y), coordinates of the three adjacent luma samples including first luma sample, second luma sample, and third luma sample are (2x−1, y), (2x, y), and (2x+1, y), respectively.

3. The method of claim 2, wherein a ratio of filter coefficients being applied to the first luma sample, the second luma sample, and the third luma sample is 1:2:1.

4. The method of claim 1, wherein if the color format is 4:2:2, the downsampled top neighboring luma samples are derived by filtering three adjacent top neighboring luma samples of the current luma block.

5. The method of claim 4, wherein if coordinates of a downsampled top neighboring luma sample is (x, y), coordinates of the three adjacent top neighboring luma samples including first top neighboring luma sample, second top neighboring luma sample, and third top neighboring luma sample are (2x−1, y), (2x, y), and (2x+1, y), respectively.

6. The method of claim 5, wherein a ratio of filter coefficients being applied to the coordinates of the first top neighboring luma sample, the second top neighboring luma sample, and the third top neighboring luma sample is 1:2:1.

7. The method of claim 1, wherein if the color format is 4:4:4, each luma sample of the current luma block is respectively derived as a corresponding downsampled luma sample without filtering.

8. The method of claim 7, wherein if coordinates of the downsampled luma sample is (x, y), coordinates of the luma sample of the current block is (x, y).

9. The method of claim 1, wherein if the color format is 4:4:4, each of the neighboring luma samples is derived as a downsampled neighboring luma sample without filtering, and
wherein if coordinates of the downsampled top neighboring luma sample is (x, y), coordinates of the top neighboring luma sample is (x, y).

10. An image encoding method performed by an encoding apparatus, the method comprising:
determining a cross-component linear model (CCLM) mode as an intra prediction mode of a current chroma block, and deriving a color format for the current chroma block;
deriving downsampled luma samples based on a current luma block;
deriving downsampled neighboring luma samples based on neighboring luma samples of the current luma block;
deriving CCLM parameters based on the downsampled neighboring luma samples and neighboring chroma samples of a current neighboring chroma block;
generating prediction samples for the current chroma block based on the CCLM parameters and the downsampled luma samples; and
encoding information on the intra prediction mode and information on the color format,
wherein downsampled luma samples are derived by filtering three adjacent current luma samples if the color format is 4:2:2.

11. The method of claim 10, wherein if coordinates of a downsampled luma sample is (x, y), coordinates of the three adjacent luma samples including first luma sample, second luma sample, and third luma sample are (2x−1, y), (2x, y), and (2x+1, y), respectively, and
wherein a ratio of filter coefficients being applied to the first luma sample, the second luma sample, and the third luma sample is 1:2:1.

12. The method of claim 10, wherein if the color format is 4:2:2, the downsampled top neighboring luma samples are derived by filtering three adjacent top neighboring luma samples of the current luma block.

13. The method of claim 12, wherein if coordinates of a downsampled top neighboring luma sample is (x, y), coordinates of the three adjacent top neighboring luma samples including first top neighboring luma sample, second top neighboring luma sample, and third top neighboring luma sample are (2x−1, y), (2x, y), and (2x+1, y), respectively, and
wherein a ratio of filter coefficients being applied to the coordinates of the first top neighboring luma sample, the second top neighboring luma sample, and the third top neighboring luma sample is 1:2:1.

14. The method of claim 10, wherein if the color format is 4:4:4, each luma sample of the current luma block is respectively derived as a corresponding downsampled luma sample without filtering, and
wherein each of the neighboring luma samples is derived as a downsampled neighboring luma sample without filtering.

15. A computer-readable digital storage medium storing instruction information causing a decoding apparatus to perform an image decoding method, the method comprising:
deriving a cross-component linear model (CCLM) mode as an intra prediction mode of a current chroma block based on prediction mode information for the current chroma block, and deriving a color format for the current chroma block,
deriving downsampled luma samples based on a current luma block,
deriving downsampled neighboring luma samples based on neighboring luma samples of the current luma block,
deriving CCLM parameters based on the downsampled neighboring luma samples and neighboring chroma samples of a current neighboring chroma block, and
generating prediction samples for the current chroma block based on the CCLM parameters and the downsampled luma samples,
wherein the downsampled luma samples are derived by filtering three adjacent current luma samples if the color format is 4:2:2.
